(19) United States
(12) Patent Application Publication
(10) Pub. No.: US 2025/0068932 A1
(43) Pub. Date: Feb. 27, 2025

(54) EVOLUTIONARY CONTEXTUAL BANDITS

(71) Applicant: International Business Machines Corporation, Armonk, NY (US)

(72) Inventor: Djallel BOUNEFFOUF, Poughkeepsie, NY (US)

(21) Appl. No.: 18/454,108

(22) Filed: Aug. 23, 2023

(51) Int. Cl. G06N 3/126

(52) U.S. Cl. CPC G06N 3/126

(57) ABSTRACT

A method for solving a contextual bandit problem using an Evolution Linear Thompson Sampling (ELINTS) algorithm is provided, wherein the method includes identifying a contextual bandit problem having exploration parameters and feature subsets, initializing a population of genomes for use with the exploration parameters and the feature subset, initializing exploration parameter values and a random feature subset, calculating an expected reward using the exploration parameters and the feature subsets, choosing an action arm A(t), observing a reward R(t) and update a cumulative reward, selecting a subset of existing genomes based on the cumulative and replacing one or more of the existing genomes with newly created offspring genomes.

### BACKGROUND

The present invention generally relates to a contextual bandit solution approach, and more specifically, to an evolutionary contextual solution approach.

The contextual combinatorial bandit problem is a variant of the extensively studied multi-armed combinatorial bandit problem, where at each iteration, the agent observes an N-dimensional context (i.e., feature vector) and uses that context, along with the rewards of the arms played in the past, to decide which arm to play to maximize the reward. The objective of the agent is to learn the relationship between the context and reward, in order to find the best arm-selection policy for maximizing the cumulative reward over time. The basic formulation of a stochastic Contextual bandit (MAB) problem can be simply stated as 1) there are K arms, where each arm has a fixed, unknown and independent probability-law of reward; 2) at each step, a player chooses an arm and receives a reward; and 3) the reward is drawn according to the selected arm's law and it is independent of previous actions. The more information that is known about a situation, the better chance there is to optimize the solution and to identify the best possible reward.

As an important practical problem in many real-world applications, online learning solves the challenge when the data is only revealed in a sequential fashion and subsequently used to update the best predictive model for unseen future rewards or for data corresponding to the features of the data. If we consider the many real-world scenarios that apply to this type of situation, the reward feedback serves as the only place for the agent to efficiently learn from the available historical experience in a sequential order. As such, sequential decision making is a field where this type of setting is especially important. It is concerned with an environment where the agent needs to select the best available action to take at each iteration in order to maximize the cumulative reward across a period of time. The key to the solution of this type of problem is to find an optimal trade-off between two processes in the decision making process: 1) the exploitation of the learned reward correspondence from the known actions, and 2) the exploration of unfamiliar actions.

The contextual bandit (MAB) problem describes the mathematical formulation of this framework where each bandit arm maps to a usually fixed but always unknown reward distribution, and at each step the player picks an arm to play, receives a reward feedback and updates the data according to the received feedback. These online learning agents are updated from trials and errors based on feedback received in a temporal sequence, and they are widely applied to applications such as user modeling and recommendation systems. On the other hand, evolutionary computation solves the problem using population-based trials and errors. Usually inspired by biological evolution, these global optimization learners typically start with a pool of candidate solutions, and iteratively update them by stochastically removing the less favorable solutions based on some notion of fitness score and by introducing incremental mutations to the more favorable solutions in a way that mimics the natural selection process. And because these methods collect feedback from a pool of representations instead of merely from a temporal sequence of representations, they usually reach a larger set of solution space, yield multiple optimal solutions, and benefit from the parallelism offered by high-performance distributed computing.

Unfortunately however, current bandit algorithms still have room for improvement in their applicational accuracy and effectivity.

### SUMMARY

A method for solving a contextual bandit problem using an Evolution Linear Thompson Sampling (ELINTS) algorithm is provided, wherein the method includes identifying a contextual bandit problem having exploration parameters and feature subsets, initializing a population of genomes for use with the exploration parameters and the feature subset, initializing exploration parameter values and a random feature subset, calculating an expected reward using the exploration parameters and the feature subsets, choosing an action arm A(t), observing a reward R(t) and update a cumulative reward, selecting a subset of existing genomes based on the cumulative and replacing one or more of the existing genomes with newly created offspring genomes.

Embodiments of the invention are also directed to computer-implemented methods and computer program products having substantially the same features and functionality as the computer system described above.

Additional technical features and benefits are realized through the techniques of the present invention. Embodiments considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention;

FIG. 2 is an operational block diagram illustrating a method for solving a contextual bandit problem using an Evolution Linear Thompson Sampling (ELINTS) algorithm, in accordance with one or more embodiments of the present invention; and

FIG. 3 shows a graph illustrating the performance results of the method of the invention, in accordance with one or more embodiments of the present invention.

### DETAILED DESCRIPTION

As discussed briefly above, the contextual bandit approach iteratively updates from trials and errors based on feedback received in a temporal sequence, while the evolutionary computation approach solves the problem using population-based trials and errors and which iteratively updates by stochastically removing the less favorable solutions by introducing incremental mutations responsive to more favorable solutions in a way that mimics the natural selection process. However, despite the popularity of both schools of machine learning, there has been very little research devoted to solving the problems by combining the effective learning of sequential data streams based on ongoing feedback and the parallel global optimization of the evolutionary computation approach. Essentially using the combination (i.e., intersection) of the contextual bandit approach and the evolutionary computation approach. As discussed further hereinbelow, one embodiment of the method of the invention provides a genetic algorithm approach, referred to as the Evolutionary Thompson Sampling (ELITS) algorithm, which demonstrates a clear problem solving advantage over current bandit algorithms in nonstationary contextual bandit scenarios. It should be appreciated that the method of the invention directly optimizes and updates the bandit agent with explicit genetic algorithm approaches.

As a background, the contextual bandit (MAB) problem describes a sequential decision making process with reinforcement learning, where at each step, the agent selects an action from a finite action set and aims to maximize the cumulative reward over time. There have been multiple optimal solutions proposed in both stochastic and adversarial formulations, including the Bayesian formulation which includes an algorithm that iterates through each round. The contextual bandit setting can be given by the following algorithm which includes initializing context vectors for each arm: theta_1,theta_2, . . . , theta_K (D-dimensional), initializing the total rewards for each arm: total_rewards_1, total_rewards_2, . . . , total rewards_K, and initializing the context features for each round: context_features_1, context_features_2, . . . , context features_T. For t=1 to T: receive the context vector context_1, for k=1 to K: calculate the estimated reward for arm k using theta_k^{T}*context_t, choose an action arm A(t) by selecting the arm with the highest estimated reward, observe the reward R(t) for the chosen arm A(t) and update the context features for the next round: context_features_{t+1}.

It should be appreciated that in the above algorithm, K represents the number of arms (actions) available in the contextual bandit problem, D represents the dimension of the context (feature) vector associated with each arm, T is the total number of rounds (iterations) for which the algorithm will run, theta_k is a D-dimensional vector representing the context parameter for arm k, total_rewards_k represents the cumulative rewards obtained from arm k and the context_features_t is the context vector at round t, A(t) represents the chosen action (arm) at round t and R(t) is the observed reward for the chosen action at round t.

The above algorithm iterates through each round, where at the beginning of each round, the algorithm receives a context vector and calculates, for each arm, the estimated reward responsive to the context parameter and the context vector. The algorithm then selects the action with the highest estimated reward. After observing the reward, the algorithm updates the total rewards for the chosen arm and prepares the context features for the next round. This basic contextual bandit setting represents a simplified scenario where the algorithm aims to maximize the cumulative reward over time by selecting the best arm based on the estimated reward using contextual information.

In more complex scenarios, more advanced algorithms (e.g., Contextual Thompson Sampling) or other exploration-exploitation strategies may be applied to achieve improved performance. For example, consider the Thompson Sampling (TS) algorithm being applied to a contextual bandit problem. For a complex contextual bandit problem, the Thompson Sampling algorithm iterates through each round, where at the beginning of each round the algorithm receives a context vector. For each arm, the algorithm samples a context parameter from the posterior distribution using the observed rewards and their contexts. The algorithm then selects the action with the highest expected reward based on the sampled context parameters. After observing the actual reward, the algorithm updates the posterior distribution parameters for the chosen arm.

Consider the Contextual Thompson Sampling for a Contextual Bandit problem, where the algorithm includes initializing context vectors for each arm: theta_1, theta_2, . . . , theta_K (D-dimensional) and initializing parameters for prior distributions: alpha, beta for each arm. Then, for t=1 to T: receive the context vector context_t and for k=1 to K: sample theta_hat_k from the posterior distribution give the observed rewards and the contexts for arm k. At this point, an action arm A(t) is chosen by selecting the arm with the maximum sampled value of theta_hat_k\hat{ }T*context_t and the reward R(t) for the chosen arm A(t) is observed.

It should be appreciated that in the above algorithm, K represents the number of arms (actions) available in the contextual bandit problem, D represents the dimension of the context (feature) vector associated with each arm, T is the total number of rounds (iterations) for which the algorithm will run, theta_k is a D-dimensional vector representing the context parameter for arm k, alpha and beta are parameters for the Beta distribution used as priors for the arm's reward distribution, theta_hat_k represents the sampled context parameter for arm k, context_t is the context vector at round t, A(t) represents the chosen action (arm) at round t and R(t) is the observed reward for the chosen action at round t. The algorithm iterates through each round and it receives a context vector at the beginning of each round. For each arm, it samples a context parameter from the posterior distribution using the observed rewards and contexts. It then selects the action with the highest expected reward based on the sampled context parameters. After observing the reward, the algorithm updates the posterior distribution parameters for the chosen arm.

Genetic algorithms (GA) describe a class of evolutionary algorithms that mimic the natural selection process in biology where the genomes within the population evolves by competition, selection, mutation, and crossover of genetic components and as such, the genetic algorithm maintains an evolving population of candidate solutions. For each generation, t, a fitness score is computed for each candidate model m, Mₜ, and only a subset of the candidate models, deemed to be ‘fit’ enough by the fitness scores (i.e., the elites), are kept in the population of the next generation. The ‘not-so-fit’ models which don't match the criterion are eliminated, making room for new individuals. These ‘fitter’ models are then used as “parents”, to be paired up to generate “offspring”. These offspring are then introduced into the population of the next generation until the next generation is full. To introduce genetic diversity, the genetic algorithm then performs a number of mutations in randomly selected models in the population. This process is performed generation by generation until the ‘fittest model’ in the population is fit enough for the problem.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for solving a contextual bandit problem using an Evolution Linear Thompson Sampling (ELINTS) algorithm 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

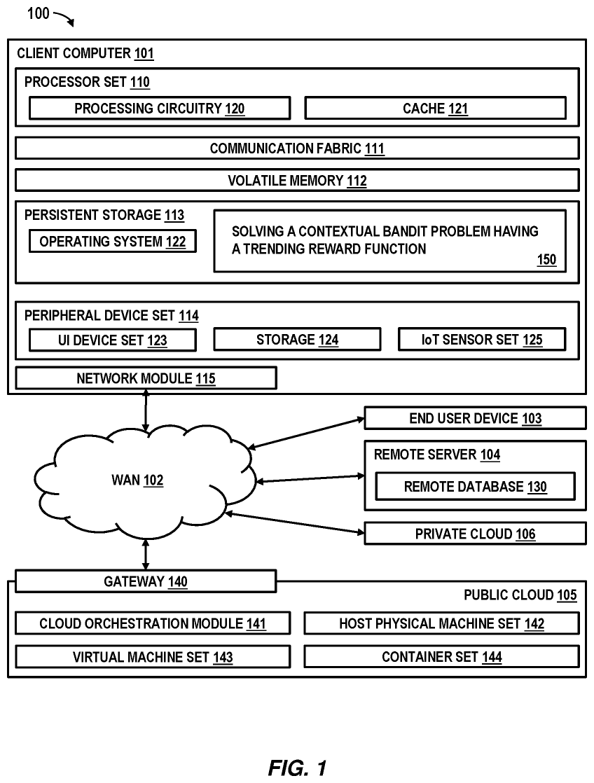

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

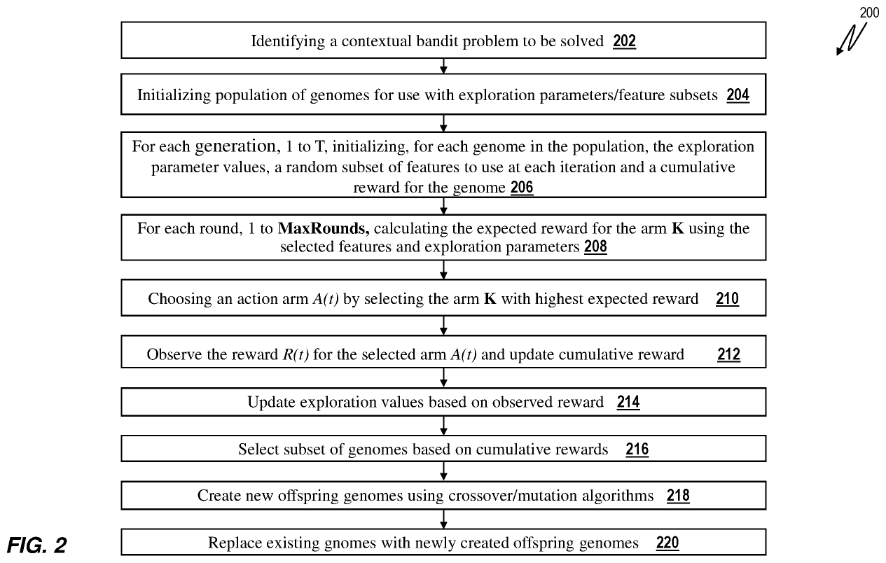

In accordance with an embodiment and referring to FIG. 2, a method 200 for solving a contextual bandit problem using an Evolution Linear Thompson Sampling (ELINTS) algorithm is provided and includes identifying a contextual bandit problem to be solved, as shown in operational block 202. The identified contextual bandit problem should include a plurality of identified input parameters such as, a number of arms (i.e., actions) K, a total number of features D, a total number of generations T, a population size “PopSize”, a probability of mutation “MutProb” and a total number of rounds (iterations) for each genome evaluation “MaxRounds”. The method 200 includes initializing a population of genomes to be used for exploration parameters and feature subsets, as shown in operational block 204. For each generation (i.e., Generation=1 to T) the method 200 includes initializing, for each genome in the population, the exploration parameter values, a random subset of features to use at each iteration and a cumulative reward for the genome, as shown in operational block 206. For each round (i.e., Round=1 to MaxRounds) the method 200 includes calculating the expected reward for the arm K using the selected features and exploration parameters, as shown in operational block 208.

Once the expected reward for the arm K is calculated, an action arm A(t) is chosen by selecting the arm K having the highest expected reward, as shown in operational block 210. The reward R(t) for the selected action arm A(t) is then observed and the cumulative reward for this genome is updated, as shown in operational block 212. At this point, the method 200 includes updating the exploration values based on the observed reward, as shown in operational block 214, wherein the exploration values may be updated using a genetic algorithm (e.g., mutation algorithm, crossover algorithm, etc.). Once the exploration values are updated, a subset of genomes are selected, as shown in operational block 216, wherein the subset of genomes are selected based on their cumulative rewards using genetic selection. The method 200 further includes creating new offspring genomes using a crossover algorithm and a mutation algorithm on the selected subset of genomes, as shown in operational block 218, and replacing some of the existing genomes in the population with the newly created offspring genomes, as shown in operational block 220.

It should be appreciated that the method 200 of the invention includes iterating through each generation and for each genome in the population, it initializes the exploration parameters and the random subset of features. The method 200 then includes simulating rounds of Linear Thompson Sampling, where the expected rewards are calculated using selected features and exploration parameters. After observing the actual reward, the exploration parameters are updated. At this point, the genetic algorithm component of the method 200 selects a subset of genomes based on their performance using genetic selection. The method 200 then creates new offspring genomes through crossover and mutation operations performed on the selected genomes, allowing for the evolution of exploration parameters and feature subsets.

It should be appreciated that to confirm the effectivity of the method 200 of the invention, the method 200 was evaluated in four settings: (1) the bandits with a stationary reward function; (2) the bandits with a nonstationary reward function; (3) an ablation study of different genetic algorithm components in Evolution Linear Thompson sampling where the cumulative rewards of each agent over the learning iterations was reported; and (4) a real-world application of the multi-armed bandit environment and control problem. Regarding the multi-armed bandit environment, the method 200 was first evaluated in simulated environment of Bernoulli contextual bandit, where K action arms were each randomly assigned with a different probability of giving a reward of 1 or 0. In nonstationary environments, the reward distribution was changed every n rounds (n=10 was used throughout the evaluation). Regarding baselines and variants, the simulated environment had three baselines. Random is a random agent that picks a random action for each round. It should be appreciated that Upper Confidence Bound, or UCB1, and the Thompson Sampling (TS) are two theoretically optimal solutions. The method 200 includes two series of variants of the Evolution Linear Thompson sampling. In the first evaluation, the effect of the population size relative to the agent performance was tested. For instance, the agent was denoted as ELITS-100 if the population size is 100. Additionally, for this evaluation, the mutation rate was set to be 10. In the second evaluation the effect of the number of mutations relative to the agents performance was tested. For instance, the agent was denoted as ELITS-mute-100 if the agent randomly applied 100 mutations to its population. Additionally, for this evaluation, the population size was set to be 50.

In the simulation, multiple instances of the environments were randomly

generated and multiple instances of the agents were randomly initialized. In each world instance, the agents were allowed to make decisions for 100 steps and reveal the reward at each step as feedback. For all of the evaluations, there were at least 100 random trials for each agent and the mean and standard errors were reported.

It should be noted that in the stationary settings the method 200 of the invention (i.e., ELINTS) is as good as the Thompson Sampling, making the top 2 in all three scenarios. However, in the nonstationary settings, the method 200 of the invention (i.e., ELINTS) significantly outperforms the baselines. By varying the population size, it was noticed that the bigger the population size, the better the result.

The method of the invention was evaluated on a Customer Assistant, a proprietary multi-skill dialog orchestration dataset. This type of application motivates the contextual bandit with sparse and noisy feedback setting because there is naturally two types of rewards that can be collected: 1) Noisy rewards, where this reward is an estimated reward that is obtained from the time the user spent in the clicked link recommended. So, the historical data is used to define the maximum and minimum time spent in a clicked link, and to normalize the reward to be between [0,1]; and 2) Sparse rewards, where this reward is based on the number of stars a user is giving to the answer received, where the evaluation can receive a maximum of five (5) stars and a minimum of zero (0) stars, and where the results are normalized to be between [0,1]. The Customer Assistant orchestrates nine (9) domain specific agents which are arbitrarily denoted as Skill1, . . . , Skill9 in the following discussion. In this application, example skills lie in the domains of payroll, compensation, travel, health benefits, etc. In addition to a textual response to a user query, the skills orchestrated by the Customer Assistant also return the following features: 1) an intent, 2) a short string descriptor that categorizes the perceived intent of the query, and 3) a confidence value, which is a real value between 0 and 1 that indicates how confident a skill is that its response is relevant to the query. It should be appreciated that skills have multiple intents associated with them. Thus, the orchestrator uses all the features associated with the query and the candidate responses from all the skills to choose which skill should carry the conversation. The Customer Assistant dataset contains 28,412 events associated with a correct skill response. Each query is encoded by averaging 50 dimensional GloVe word embeddings for each word in each query and for each skill a feature set is created that includes its confidence and a one-hot encoding of its intent. In this example, the skill feature set size for Skill1, . . . , Skill9 are 181, 9, 4, 7, 6, 27, 110, 297, and 30 respectively. The query features and all of the skill features are concatenated to form a 721 dimensional context feature vector for each event in this dataset. In a live setting, the query features are immediately calculable or known, whereas the confidence and intent necessary to build a skill's feature set are unknown until a skill is executed. And, because the confidence and intent for a skill are both accessible post execution, they are revealed together.

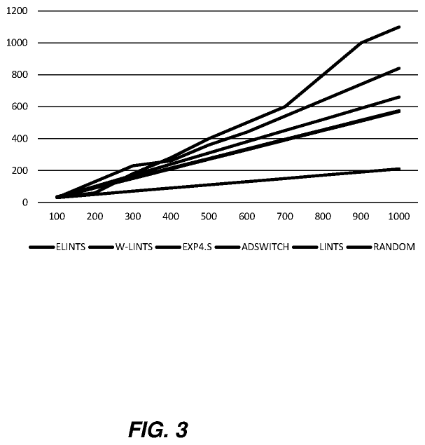

Regarding the baseline, the five control agents were evaluated as follows. First, the Random agent randomly picks an action value in every action dimension in each decision step. One of the five control agents is a state-of-the-art agent called W-LINTS where a window that only considers a limited number of trial in the history to update the system is used. EXP4.S is also a state of the art approach that deals with nonstationary problems, as it is an algorithm that puts an exponential decay on the reward function. Adswitch is also an algorithm from the state of the art that switches the reward distribution assumption after each episode. As shown in FIG. 3, the method 200 of the invention yielded the optimal solution, in that every intervention plan extracted on its curve will maximize the amount of reward. Accordingly, an embodiment of the method 200 is a hybrid online learning framework that combines the update principles of the genetic algorithm to a bandit algorithm and is successful in a nonstationary setting regarding contextual bandits, distributed system and complex tasks.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for solving a contextual bandit problem using an Evolution Linear Thompson Sampling (ELINTS) algorithm, the method comprising:
identifying a contextual bandit problem having exploration parameters and feature subsets;
initializing a population of genomes for use with the exploration parameters and the feature subsets;
initializing exploration parameter values and a random feature subset;
calculating an expected reward using the exploration parameters and the feature subsets;
choosing an action arm A(t);
observing a reward R(t) and update a cumulative reward;
selecting a subset of existing genomes based on the cumulative; and
replacing one or more of the existing genomes with newly created offspring genomes.

2. The method of claim 1, wherein the contextual bandit problem includes a plurality of input parameters, wherein the plurality of input parameters include a number of arms, a total number of features, a total number of generations, a population size, a probability of mutation and a total number of iterations for each genome evaluation.

3. The method of claim 1, wherein initializing a population of genomes includes iterating through a plurality of generations and for each generation, identifying the population of genomes.

4. The method of claim 1, wherein initializing a population of genomes include initializing the exploration parameters and the random feature subset for each genome in the population of genomes.

5. The method of claim 1, wherein calculating an expected reward includes calculating the expected reward for an arm K for each iteration and identifying an arm K with the highest expected reward.

6. The method of claim 5, wherein choosing an action arm A(t) includes selecting an action arm A(t) by selecting the arm K having the highest expected reward.

7. The method of claim 6, wherein observing a reward R(t) includes observing the reward R(t) for the selected action arm A(t) and updating a cumulative reward for this genome.

8. The method of claim 7, wherein observing a reward R(t) further includes updating exploration values based on the observed reward R(t) using at least one of a mutation algorithm and a crossover algorithm.

9. The method of claim 5, wherein selecting a subset of existing genomes includes selecting the subset of existing genomes using a genetic selection approach.

10. The method of claim 1, wherein replacing existing genomes includes creating the newly created offspring genomes by applying a crossover algorithm and a mutation algorithm on the selected subset of existing genomes.

11. A computing system, comprising:
a machine learning system for implementing a method for solving a contextual bandit problem using an Evolution Linear Thompson Sampling (ELINTS) algorithm, wherein the method includes:
identifying a contextual bandit problem having exploration parameters and feature subsets;
initializing a population of genomes for use with the exploration parameters and the feature subsets;
initializing exploration parameter values and a random feature subset;
calculating an expected reward using the exploration parameters and the feature subsets;
choosing an action arm A(t);
observing a reward R(t) and update a cumulative reward;
selecting a subset of existing genomes based on the cumulative; and
replacing one or more of the existing genomes with newly created offspring genomes.

12. The method of claim 11, wherein the contextual bandit problem includes a plurality of input parameters, wherein the plurality of input parameters include a number of arms, a total number of features, a total number of generations, a population size, a probability of mutation and a total number of iterations for each genome evaluation.

13. The method of claim 11, wherein initializing a population of genomes includes iterating through a plurality of generations and for each generation, identifying the population of genomes.

14. The method of claim 11, wherein initializing a population of genomes include initializing the exploration parameters and the random feature subset for each genome in the population of genomes.

15. The method of claim 11, wherein calculating an expected reward includes calculating the expected reward for an arm K for each iteration and identifying an arm K with the highest expected reward.

16. The method of claim 15, wherein choosing an action arm A(t) includes selecting an action arm A(t) by selecting the arm K having the highest expected reward.

17. The method of claim 16, wherein observing a reward R(t) includes observing the reward R(t) for the selected action arm A(t) and updating a cumulative reward for this genome.

18. The method of claim 17, wherein observing a reward R(t) further includes updating exploration values based on the observed reward R(t) using at least one of a mutation algorithm and a crossover algorithm.

19. The method of claim 15, wherein selecting a subset of existing genomes includes selecting the subset of existing genomes using a genetic selection approach.

20. A computer program product comprising a computer readable storage medium having program instructions embodied therewith, the program instructions executable by a processor to cause the processor to perform operations for implementing a contextual bandit problem using an Evolution Linear Thompson Sampling (ELINTS) algorithm, the operations comprising:
identifying a contextual bandit problem having exploration parameters and feature subsets;
initializing a population of genomes for use with the exploration parameters and the feature subsets;
initializing exploration parameter values and a random feature subset;
calculating an expected reward using the exploration parameters and the feature subsets;
choosing an action arm A(t);
observing a reward R(t) and update a cumulative reward;
selecting a subset of existing genomes based on the cumulative; and
replacing one or more of the existing genomes with newly created offspring genomes.
